(19) United States
(12) Patent Application Publication
(10) Pub. No.: US 2026/0094221 A1
(43) Pub. Date: Apr. 2, 2026

(54) ARTIFICIAL INTELLIGENCE (AI) PATENT COACH

(71) Applicant: GUIDED TECHNOLOGIES IP, LLC, Cape Coral, FL (US)

(72) Inventors: Joseph MERCOLA, Ormond Beach, FL (US); Peter Cobabe, Haiku, HI (US); Joshua Pellicer, Haiku, HI (US)

(21) Appl. No.: 18/899,735

(22) Filed: Sep. 27, 2024

(51) Int. Cl. G06Q 50/18; G06Q 10/0633

(52) U.S. Cl. CPC G06Q 50/184; G06Q 10/0633

(57) ABSTRACT

Systems and methods for software-based patent application drafting. Systems and methods may include receiving, by a computer system, unstructured input describing an invention; classifying, by the computer system, the invention into a technology area; generating, by the computer system, a set of claims based on the unstructured input and technology area; drafting, by the computer system, a patent specification including a background, summary, description of drawings, and detailed description; performing, by the computer system, a vectorized prior art search using a database of patent documents; iteratively refining, by the computer system, the claims and specification based on the prior art search results; generating, by the computer system, flowcharts and drawing descriptions for the invention; and outputting, by the computer system, a patent-ready application.

### FIELD OF THE INVENTION

The present invention relates generally to software-based patent application drafting systems and methods. More specifically, the invention pertains to the application of artificial intelligence in legal document preparation, with a particular focus on automated intellectual property protection.

### BACKGROUND

The field of patent application drafting has long been plagued by several significant challenges that hinder the efficient protection of intellectual property. These challenges have persisted despite the increasing importance of patents in today's rapidly evolving technological landscape.

### SUMMARY

This invention addresses the complex and multifaceted domain of patent application drafting, leveraging advanced computational techniques to streamline and enhance the process. By integrating artificial intelligence algorithms with comprehensive patent law knowledge, the system aims to revolutionize the way patent applications are prepared, reviewed, and refined.

The field of this invention encompasses the intersection of several technological and legal disciplines, including but not limited to:
1. Natural language processing for analyzing inventor inputs and generating coherent legal documents;
2. Machine learning algorithms for technology classification and prior art analysis;
3. Expert systems designed to emulate the decision-making processes of experienced patent attorneys;
4. Vector-based search methodologies for efficient and accurate prior art identification;
5. Automated claim drafting and refinement techniques;
6. Intelligent document structuring and formatting in compliance with patent office requirements;
7. Collaborative interfaces facilitating interaction between the AI system and human experts.

This invention is particularly relevant to law firms, corporate intellectual property departments, individual inventors, and patent offices seeking to improve the efficiency, consistency, and quality of patent application drafting. By automating various aspects of the drafting process while maintaining the critical oversight of human experts, the invention aims to address the growing demand for rapid, high-quality intellectual property protection in an increasingly innovation-driven global economy.

The field of patent application drafting has long been plagued by several significant challenges that hinder the efficient protection of intellectual property. These challenges have persisted despite the increasing importance of patents in today's rapidly evolving technological landscape.

One of the most pressing issues is the time-consuming nature of the patent application process. Traditionally, drafting a comprehensive patent application requires extensive hours of research, writing, and revision. This prolonged process often spans weeks or even months, during which time the competitive advantage of the invention may diminish or be lost entirely.

Closely related to the time constraint is the loss of inventor momentum and excitement. As the drafting process drags on, inventors may lose enthusiasm for their innovation or become distracted by new projects. This waning interest can lead to less detailed input from inventors, potentially resulting in patent applications that fail to capture the full scope and value of the invention.

Another significant challenge is the inconsistent quality and structure of patent applications. The quality of a patent application can vary greatly depending on the experience and expertise of the drafter, as well as the time and resources allocated to the process. This inconsistency can lead to weakened patent protection and increased vulnerability to challenges or invalidation attempts.

Furthermore, the patent drafting process faces difficulty in adapting to different technology areas. As technology rapidly evolves and new fields emerge, patent drafters must constantly update their knowledge and adapt their approach. This requirement for continuous learning and adaptation can lead to delays and potential errors in drafting applications for cutting-edge technologies.

Existing solutions to these challenges have proven inadequate. The traditional approach of manual drafting by patent attorneys, while thorough, exacerbates the issues of time consumption and inconsistency. Experienced patent attorneys can produce high-quality applications, but the process remains slow and resource-intensive.

Basic automation tools have been introduced to streamline certain aspects of patent drafting. These tools typically focus on document management, claim formatting, or prior art searching. However, they fall short in addressing the core challenges of drafting the substantive content of the application.

Some limited AI assistance has been implemented for specific tasks within the patent drafting process. These solutions might help with patent classification or basic language processing. However, they lack the comprehensive approach needed to revolutionize the entire drafting process from initial inventor input to a complete, filing-ready application.

In summary, the field of patent application drafting faces significant challenges that current solutions have failed to adequately address. There is a clear need for a more efficient, consistent, and adaptable approach to patent drafting that can keep pace with the rapid advancement of technology while maintaining the high quality necessary for robust patent protection. The AI Patent Coach system is an innovative software solution designed to revolutionize the patent application drafting process. This system leverages advanced artificial intelligence technologies to automate and streamline the creation of high-quality patent applications, addressing the challenges of time-consuming drafting, inconsistent quality, and the need for adaptability across various technology areas.

The AI Patent Coach system comprises several key features and advantages:
1. Automated processing of unstructured inventor input, rapidly converting ideas into structured patent applications while preserving inventor momentum and excitement.
2. Intelligent technology classification, automatically adapting the drafting process to specific fields of invention.
3. Comprehensive claim generation, creating a hierarchy of claims from broad independent claims to specific dependent claims.
4. Automated drafting of full patent specifications, including background, summary, description of drawings, and detailed description.
5. Vectorized prior art searching using a custom AI-enhanced USPTO database, ensuring thorough novelty assessment.
6. Iterative refinement of claims and specifications based on prior art analysis, enhancing the likelihood of patent approval.
7. Automatic generation of flowcharts and drawing descriptions, supporting visual representation of the invention.
8. Modular functionality allowing humans to request specific sections or refinements, optimizing their expertise and time.
9. Continuous improvement through machine learning, incorporating feedback from humans and successful patents.
10. Adaptability to various patent types, including utility, method, and apparatus claims.

The potential impact of the AI Patent Coach on the patent drafting industry is significant. By dramatically reducing the time and effort required to create patent applications, the system enables faster innovation cycles and more efficient use of intellectual property resources.

Humans can focus on high-value tasks such as strategic advising and complex legal analysis, while inventors benefit from a more streamlined and engaging patenting process.

Furthermore, the AI Patent Coach has the potential to democratize access to patent protection by making the drafting process more accessible to individual inventors and small businesses. The system's ability to maintain consistent quality across various technology areas may also lead to improved patent quality overall, potentially easing the burden on patent examiners and reducing the time to patent grant.

In summary, the AI Patent Coach system represents a transformative approach to patent application drafting, offering significant time and resource savings, improved quality and consistency, and the potential to accelerate innovation across industries.

The present invention provides a system for automated patent application drafting, comprising: a processor; a memory storing instructions that, when executed by the processor, cause the system to: receive unstructured input describing an invention; classify the invention into a technology area; generate a set of claims based on the unstructured input and technology area; draft a patent specification including a background, summary, description of drawings, and detailed description; perform a vectorized prior art search using a database of patent documents; iteratively refine the claims and specification based on the prior art search results; generate flowcharts and drawing descriptions for the invention; and output a patent-ready application.

In one aspect, the system classifies the invention into a technology area by analyzing the unstructured input using natural language processing techniques. The system generates the set of claims by creating a hierarchy of claims starting with broad independent claims and progressing to more specific dependent claims. The vectorized prior art search involves converting patent documents into vector representations, comparing the vector representations of the patent documents to a vector representation of the invention, and identifying similar patent documents based on vector similarity.

The system iteratively refines the claims and specification by identifying potential conflicts with prior art, modifying claim language to avoid the identified conflicts, and updating the specification to support the modified claims. Flowchart generation is accomplished using diagramming tools, including but not limited to mermaid code to create visual representations of the invention's processes or components. The system also incorporates input from a human to refine specific sections of the patent application.

In addition to the system aspects, the invention also encompasses a method for automated patent application drafting and a non-transitory computer-readable storage medium storing instructions for performing the automated patent application drafting process.

The AI Patent Coach system represents a significant advancement in patent application drafting technology. By leveraging artificial intelligence and natural language processing, it addresses key challenges in the current patent drafting process, including time constraints, consistency issues, and the need for adaptability across various technology areas. The system's ability to rapidly convert unstructured inventor input into structured patent applications while maintaining high quality and legal standards has the potential to revolutionize the patent industry.

### Key Advantages of the AI Patent Coach System Include

1. Rapid processing of inventor ideas, preserving momentum and excitement in the innovation process.
2. Consistent quality across various technology areas, potentially improving overall patent quality.
3. Efficient prior art searching and iterative refinement, enhancing the likelihood of patent approval.
4. Automated generation of visual aids, supporting clearer communication of inventive concepts.
5. Flexibility for human input and refinement, optimizing the expertise of patent professionals.
6. Continuous improvement through machine learning, incorporating feedback from successful patents and attorney edits.

The AI Patent Coach system has the potential to significantly impact the patent industry by streamlining the drafting process, reducing time and resource requirements, and potentially democratizing access to patent protection for individual inventors and small businesses. By automating routine aspects of patent drafting, it allows patent attorneys to focus on high-value tasks such as strategic advising and complex legal analysis, ultimately contributing to a more efficient and innovative intellectual property landscape.

### BRIEF DESCRIPTION OF THE DRAWINGS

FIG. 1 is a system architecture diagram illustrating the main components of the AI Patent Coach system, including the input processing module, technology classification module, claim generation module, specification drafting module, prior art search module, refinement module, drawing generation module, and output generation module, consistent with embodiments of the present disclosure.

FIG. 2 is a flowchart depicting the overall process flow of patent application drafting using the AI Patent Coach system, from receiving unstructured inventor input to producing the final patent-ready application, consistent with embodiments of the present disclosure.

FIG. 3 is a flowchart illustrating the technology classification module, showing the steps involved in analyzing the unstructured input using natural language processing techniques and machine learning models to classify the invention into a specific technology area, consistent with embodiments of the present disclosure.

FIG. 4 is a flowchart representing the claim generation and refinement process, demonstrating the creation of a hierarchy of claims from broad independent claims to specific dependent claims, and the iterative refinement based on prior art search results, consistent with embodiments of the present disclosure.

FIG. 5 is a flowchart depicting the vectorized prior art search mechanism, showing the process of converting patent documents into vector representations, comparing them to the vector representation of the invention, and identifying similar patent documents based on vector similarity, consistent with embodiments of the present disclosure.

FIG. 6 is a user journey diagram illustrating the user interface for human input and refinement, showing how humans can interact with the system to request specific refinements and collaborate in real-time on the patent application, consistent with embodiments of the present disclosure.

### DETAILED DESCRIPTION OF THE INVENTION

The present invention provides a system and method for automated patent application drafting using artificial intelligence. This detailed description will explain the components, processes, and techniques used in the invention, including definitions of key terms and illustrative examples.

### Definitions

For the purposes of this invention:

“Unstructured input” refers to any form of inventor input that is not pre-formatted or organized in a structured manner. This may include free-form text descriptions, voice recordings, hand-drawn sketches, or responses to open-ended questions.

To “classify” the invention means to categorize the invention into one or more technological fields or areas of application based on its characteristics, components, and functionality.

“Iteratively refine” means to repeatedly modify and improve specific elements of the patent application, such as claims or descriptions, based on feedback, analysis results, or new information, with each iteration building upon the results of the previous one.

“Natural language processing techniques” encompass computational methods used to analyze, understand, and generate human language, including but not limited to tokenization, part-of-speech tagging, named entity recognition, dependency parsing, prompt creation, and semantic analysis.

“Vector representation” refers to the conversion of textual or conceptual information into a multi-dimensional numerical format that can be computationally processed and compared typically using techniques such as word embeddings or document embeddings.

“Patent-ready application” means a patent application document that meets the formal requirements for submission to a patent office, including all necessary sections, proper formatting, and consistent internal references.

“Vectorized prior art search” refers to a method of searching for relevant prior art by converting patent documents and the invention description into numerical vector representations, allowing for efficient comparison and similarity assessment using computational techniques.

“Technology area” means a specific field or domain of technology to which an invention pertains, as classified by standardized patent classification systems or custom categorization schemes used by the AI Patent Coach system.

“Flowchart-creation code” refers to computer-readable instructions or markup language used to generate visual representations of processes, algorithms, or system architectures, such as mermaid code or other diagramming tools.

“Patent specification” refers to the detailed written description of an invention in a patent application, typically including background, summary, detailed description, and description of drawings sections, which together provide a complete disclosure of the invention.

“Prior art” means any evidence that an invention is already known, including previous patents, published patent applications, scientific literature, public disclosures, or commercially available products, which is used to determine the novelty and non-obviousness of a claimed invention.

### System Architecture and Process Flow

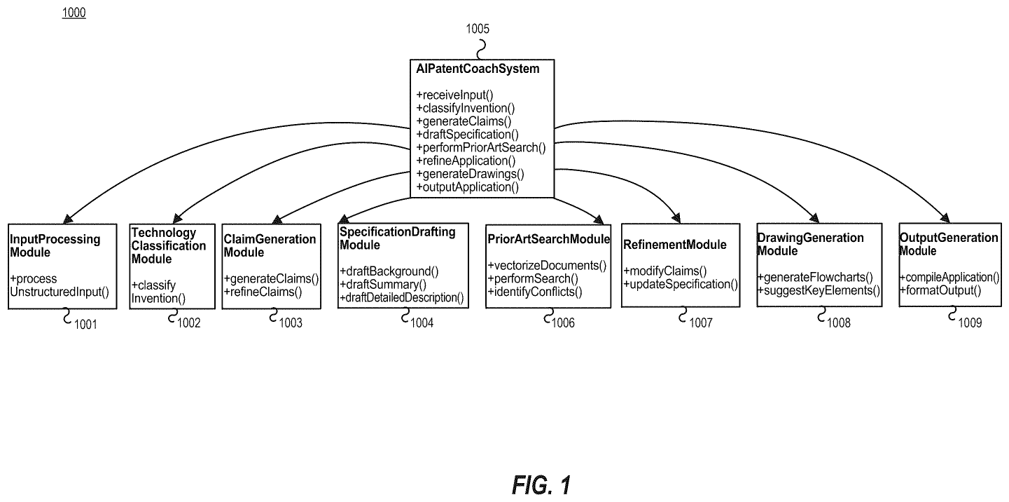

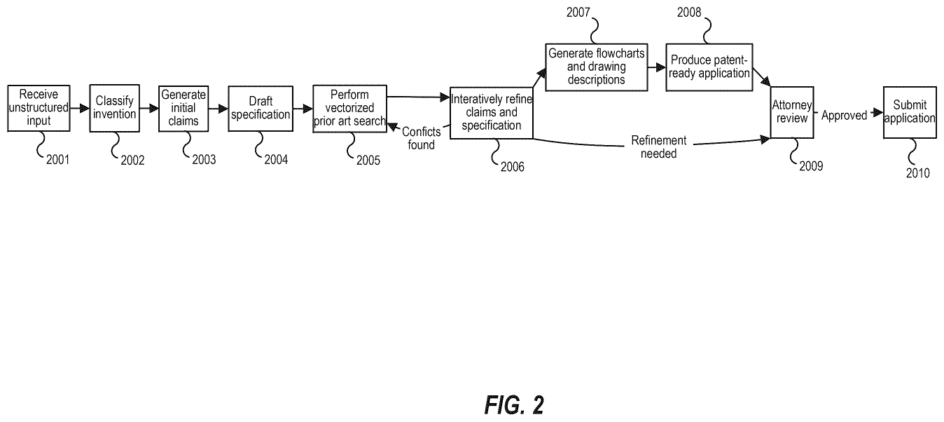

The AI Patent Coach system comprises several interconnected modules that work together to process inventor input and generate a patent-ready application. FIG. 1 illustrates the overall system architecture 1000 of AI Patent Coach System 1005, while FIG. 2 provides a detailed process flow, consistent with embodiments of the present disclosure. The key components and their functions are described below:

### 1. Input Processing Module

The input processing module 1001 receives and interprets unstructured inventor input using advanced natural language processing (NLP) techniques. Input processing module 1001 performs as follows:
a) The module 1001 accepts various input formats, including free-form text, voice recordings, and structured questionnaires.
b) Voice inputs are transcribed using speech-to-text algorithms.
c) The text is then processed using named entity recognition to identify key components, processes, and novel aspects of the invention.
d) Dependency parsing is applied to understand relationships between different elements of the invention.
e) The module employs BERT (Bidirectional Encoder Representations from Transformers) or similar transformer-based models fine-tuned on patent documents to extract key invention details from the unstructured input.

### 2. Technology Classification Module

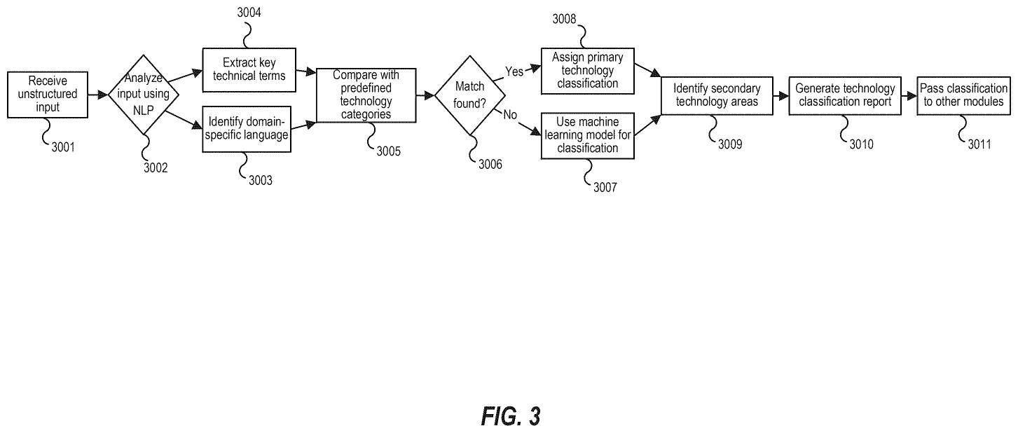

Technology classification module 1002 analyzes the processed input to classify the invention into appropriate technology areas. FIG. 3 illustrates the classification process in detail. The steps include:
a) After receiving unstructured input 3001 and analyzing using NLP 3002, extracting relevant keywords and phrases using TF-IDF (Term Frequency-Inverse Document Frequency) analysis 3004 and identify domain-specific language 3003.
b) After comparing the results with predefined technology categories 3005, applying a pre-trained multi-label classification model (e.g., XGBoost or Random Forest) 3006 to seek matches and thus assign primary categories 3008 and secondary technology categories 3009.
c) Utilizing word embeddings (e.g., Word2Vec or GloVe) to capture semantic similarities between the invention description and known technology area descriptions 3007 if no match found to then assign a primary classification.
d) Implementing a hierarchical classification system to determine both broad (e.g., “Computer Science”) and specific (e.g., “Natural Language Processing”) technology categories 3007, 3008, 3009.
e) Employing ensemble methods to combine the results of multiple classification techniques for improved accuracy to generate a technology classification report 3010 which will be passed on the classification to other modules 3011.

### 3. Claim Generation Module

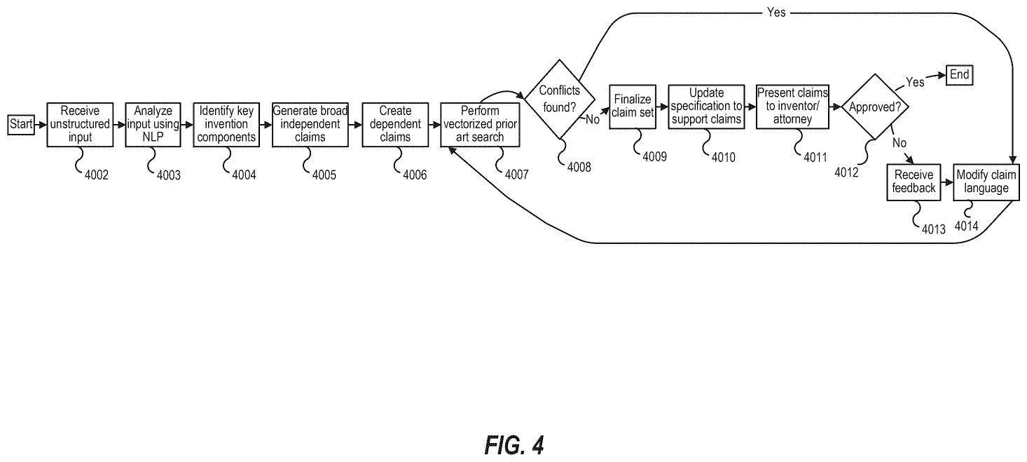

Based on the classified technology area and extracted invention details, claim generation module 1003 generates a hierarchical set of claims. FIG. 4 further describes the process in detail. The process of drafting broad claims includes:
a) Receiving unstructured input 4002, analyzing the input using NLP 4003, and identifying the core inventive concept using the extracted key components and processes 4004.
b) Generating a broad independent claim that covers the core concept without unnecessary limitations 4005.
c) Utilizing a claim template database specific to the identified technology area at 4005.
d) Employing a recursive neural network (RNN) or transformer-based model trained on patent claims to generate claim language at 4005.
e) Applying legal and technical heuristics to ensure claim breadth while maintaining novelty and non-obviousness.

The module 1003 then creates dependent claims by, as further described in FIG. 4:
a) Identifying optional features and specific implementations from the invention description 4004.
b) Generating dependent claims that add limitations to the independent claims at 4006.
c) Ensuring a proper claim tree structure with appropriate antecedent basis 4009.

The module 1003 then presents the claims or makes available to a human, typically an inventor, patent agent, or patent attorney, for review, for modification or approval at 4011, 4012, 4013.

### 4. Specification Drafting Module

Specification drafting module 1004 generates each section of the patent specification using specialized language models trained on patent documents. The drafting process includes:
a) Generating a background section by:
   Analyzing the technology classification to identify relevant prior art.
   Summarizing the state of the art using extractive and abstractive summarization techniques.
   Identifying problems or limitations in the prior art based on the invention description.
b) Creating a summary of the invention by:
   Extracting key points from the generated claims as disclosed in FIG. 4 4010.
   Employing a template-based approach to highlight the invention's advantages and novel aspects.
c) Composing a detailed description by:
   Breaking down the invention into its component parts and processes.
   Generating detailed explanations for each component and process using a combination of templates and natural language generation models.
   Ensuring consistency with the claims by cross-referencing claim elements.
   Providing multiple embodiments and variations of the invention to support broad claim scope.
d) Generating a brief description of the drawings by:
   Creating concise descriptions of each figure generated by the Drawing Generation Module.
   Ensuring proper numbering and cross-referencing with the detailed description.

### 5. Prior Art Search Module

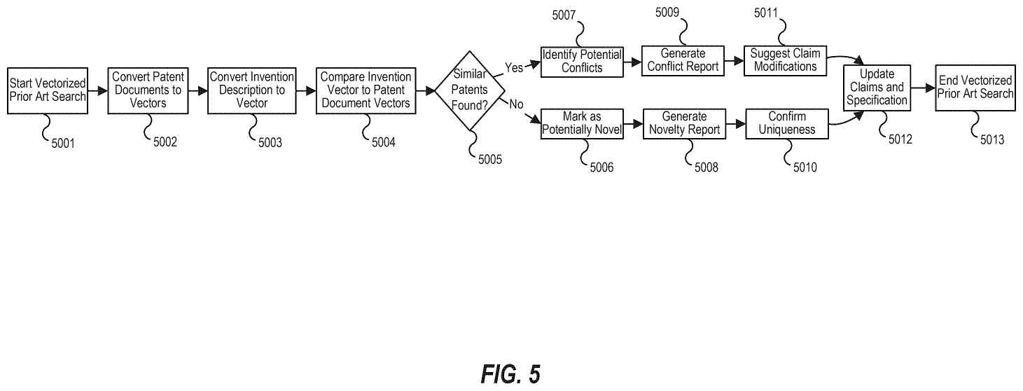

At 5001, prior art search module 1006 performs a vectorized search of prior art using a custom AI-enhanced version of the USPTO database. This module is described in detail in FIG. 5. The process includes:
a) Converting the drafted patent application and existing patent documents into high-dimensional vector representations using techniques such as Doc2Vec or BERT embeddings 5002, 5003.
b) Implementing locality-sensitive hashing (LSH) for efficient similarity search in the high-dimensional vector space 5005.
c) Calculating cosine similarity between the invention vector and prior art vectors to identify relevant documents 5004, 5005.
d) Ranking the identified prior art based on similarity scores and relevance to key aspects of the invention 5006, 5007.
e) Generating a report highlighting potential novelty or obviousness issues based on the most similar prior art documents 5008, 5009.

### 6. Refinement Module

Based on the prior art search results, refinement module 1007 iteratively refines the claims and specification as described in more detail in FIGS. 4 and 5. The iterative refinement process includes:
a) Analyzing the identified prior art to detect potential conflicts or overlaps with the current claims using semantic similarity measures 5010, 5011, 4007, 4008.
b) Generating suggestions for claim modifications to avoid conflicts and enhance novelty at 4014, 5012, such as:
   Adding specific limitations to differentiate from prior art.
   Restructuring claim elements to emphasize novel combinations.
   Introducing alternative embodiments not found in the prior art.
c) Automatically updating claim language based on these suggestions using controlled natural language generation 4014, 5012.
d) Propagating changes in the claims to the specification to maintain consistency 4010, 5012, including:
   Updating the summary of the invention.
   Modifying or adding embodiments in the detailed description.
   Revising advantage statements to reflect the refined claims.
e) Re-running the prior art search with the updated claims to verify improved novelty and non-obviousness.
f) Repeating steps a-e until a satisfactory level of novelty and non-obviousness is achieved or a maximum number of iterations is reached and ending the vectorized prior art search at 5013.

### 7. Drawing Generation Module

Drawing generation module 1008 extracts key processes, components, and relationships from the invention description to generate flowcharts and identify critical visual elements. The process includes:
a) Analyzing the detailed description to identify key components, processes, and relationships using named entity recognition and dependency parsing.
b) Generating, via a diagraming tool, including but not limited to, mermaid code to create flowcharts representing these elements, including:
   System architecture diagrams
   Process flow charts
   Data flow diagrams
   State transition diagrams.
   The drawing generation module 1008 may use, but is not limited to, the following to create charts or graphs from code, including simple markup languages to complex programming libraries and specialized tools:
   1. Graph Definition Languages and Markups
      Mermaid
      Graphviz (DOT Language)
      PlantUML
      Ditaa
      TikZ/PGF (LaTeX)
      Asymptote
      Vega and Vega-Lite
      Pikchr
   2. Programming Libraries for Charting and Plotting
      Python Libraries:
      Matplotlib
      Seaborn
      Plotly
      Bokeh
      Altair
      NetworkX
      R Libraries:
      ggplot2
      Lattice
      Shiny
      JavaScript Libraries:
      D3.js
      Chart.js
      Highcharts
      ECharts
   3. Command-line Tools
      Gnuplot
      Graphviz
   4. Markup Languages with Diagram Support
      Mermaid in Markdown
      PlantUML in Markdown
      LaTeX Packages (TikZ/PGF)
   5. Domain-Specific Languages (DSLs)
      Unified Modeling Language (UML)
      Business Process Model and Notation (BPMN)
   6. JSON/YAML Specifications for Visualizations
      Vega/Vega-Lite
      ECharts
   7. Scripting in Spreadsheet Applications
      Excel VBA
      Google Sheets Apps Script
   8. Visualization in Data Analysis Platforms
      Tableau
      Power BI
   9. Web-Based Diagram Editors with Code Export/Import
      Draw.io
      Lucidchart
   10. Other Visualization Tools and Libraries
      Processing (Java/Python Mode)
      p5.js (JavaScript)
      Leaflet.js
      Three.js
      Gephi
   11. Custom DSLs and Configurations
   12. Embedded Visualization Languages
      Jupyter Notebooks
      Mathematica
   13. APIs for Chart Generation
      Google Charts API
      QuickChart
   14. Automation Tools
      Selenium
   15. Data Flow Programming Environments
      Node-RED
   16. Domain-Specific Tools
      Bioinformatics Tools (e.g., Circos)
   17. Graphical Languages
      LabVIEW
   18. Graphical User Interfaces with Scripting
      Visio Automation
      OmniGraffle Automation
   19. SVG Editing via Code
   20. Animation and Interactive Visualizations
      Manim (Python)
   21. 3D Visualization Libraries
      VTK (Visualization Toolkit)
      Mayavi (Python)
c) Implementing a rule-based system to determine appropriate diagram types based on the invention's nature.
d) Utilizing computer vision techniques to convert hand-drawn sketches (if provided) into digital diagrams. Vision techniques include, but are not limited to, the following:
   GPT-4 with Vision
   CLIP (Contrastive Language-Image Pre-training)
   DALL·E
   DALL·E 2
   Flamingo (DeepMind)
   BLIP (Bootstrapping Language-Image Pre-training)
   BLIP-2
   PaLM-E
   VisualBERT
   ViLBERT
   OSCAR
   VinVL
   SimVLM (Simple Visual Language Model)
   Florence
   OFA (One Former All)
   BEiT (BERT Pre-training of Image Transformers)
   Vision Transformer (ViT)
   Swin Transformer
   ALBEF (Align Before Fuse)
   X-LXMERT
   UniT (Unified Transformer)
   VL-T5
   Image Captioning Models
   Optical Character Recognition (OCR) Engines (e.g., Tesseract OCR)
   Donut (Document Understanding Transformer)
   LayoutLM
   LayoutLMv2
   Keras-OCR
   EASYOCR
   CRAFT Text Detector
   Deep Text Recognition Benchmark Models
   Scene Text Recognition Models
   Visual Question Answering (VQA) Models
   Image Classification Models (e.g., ResNet, EfficientNet)
   Object Detection Models (e.g., Faster R-CNN, YOLO, SSD)
   Semantic Segmentation Models (e.g., U-Net, DeepLab)
   Instance Segmentation Models (e.g., Mask R-CNN)
   Visual Grounding Models
   Multimodal Models (e.g., LXMERT)
   Zero-Shot Image Classification Models
   Image Feature Extractors
   Image Embedding Models
   Pix2Seq
   Image-to-Text Transformers
   Visual Genome
   Scene Graph Generation Models
   Image Retrieval Systems
   Neural Style Transfer Models
   Image-to-LaTeX Converters
   Visual Relationship Detection Models
   Transformer-Based Models for Images
e) Generating textual descriptions for each proposed figure, including labels and reference numbers, using template-based natural language generation.

### 8. Output Generation Module

Output generation module 1009 compiles all generated sections into a standardized patent application format. The process includes:
a) Applying proper formatting, numbering, and cross-referencing throughout the document using rule-based algorithms.
b) Generating a table of contents and other required administrative sections.
c) Implementing a final consistency check to ensure all parts of the application align.
d) Outputting the document in multiple file formats compatible with patent office submission systems (e.g., PDF, DOCX).

### Example: Automated Drafting of a Software Patent

To illustrate the system's functionality, consider the following example of drafting a software patent for a novel machine learning algorithm:
1. At step 2001, the system (e.g., system 1005 of FIG. 1) may receive unstructured input. For example, the inventor provides an unstructured text description of their algorithm, including its purpose, key steps, and advantages over existing methods.
2. At step 2002, the system may classify the invention. For example, Input Processing Module 1001 extracts key concepts such as “gradient boosting,” “feature selection,” and “ensemble learning.”
3. Technology Classification Module 1002 categorizes the invention under “Machine Learning” and “Predictive Analytics.”
4. At step 2003, the system may generate initial claims. For example, Claim Generation Module 1003 drafts a broad independent claim: “A method for predictive modeling, comprising:
receiving a dataset;
performing feature selection on the dataset;
applying a gradient boosting algorithm to the selected features; combining multiple gradient boosting models into an ensemble; generating predictions using the ensemble model.”
5. At step 2004, the system may draft the specification. For example, Specification Drafting Module 1004 generates a detailed description, explaining each step of the algorithm, potential applications, and advantages over traditional methods.
6. At step 2005, the system may perform a vectorized prior art search consistent with FIG. 5. For example, Prior Art Search Module 1006 identifies related patents on gradient boosting and ensemble methods.
7. At step 2006, the system may iteratively refine the claims and specification. For example, Refinement Module 1007 suggests adding a limitation to the independent claim specifying a novel aspect of the feature selection process to differentiate from prior art.
8. At step 2007, the system may generate flowcharts and drawing descriptions. For example, Drawing Generation Module 1008 creates flowcharts illustrating the algorithm's steps and the ensemble model architecture.
9. At step 2008, the system may produce a patent application (e.g., a patent-ready application). For example, Output Generation Module 1009 compiles all sections into a cohesive patent application, ensuring proper formatting and cross-referencing.

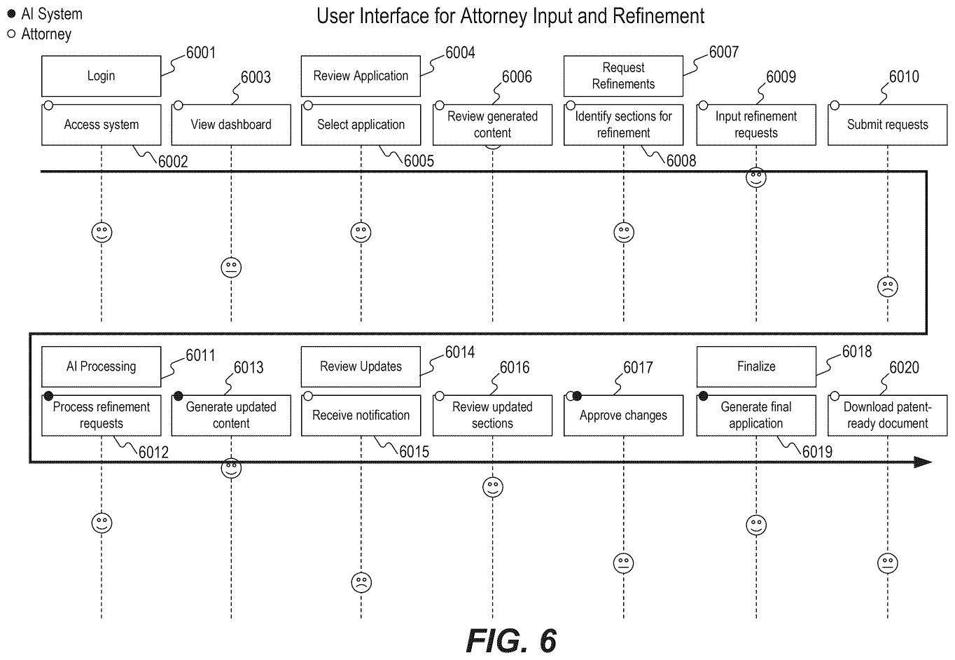

At step 2009, the system may be used by an attorney to review the patent application from step 2008 consistent with FIG. 6. As described in FIG. 6, this process includes logging in and accessing the tool 6001, 6002. The user then may view the dashboard 6003. The user may then begin the review application process 6004 in which a user may select the draft application 6005 for review. The user may then review the generated content 6006. The user may then begin the request refinements process 6007 in which the user may identify sections for refinement 6008, input refinement requests 6009, and submit those refinement requests 6010. The AI processing 6011 of the refinement processes the refinement requests 6012 and generates updated content 6013. The user may then review the updates 6014 in which the user receives a notification of the update 6015, and the user may then review updated sections 6016. The user may then approve the changes, if the user so chooses 6017. If the user seeks to make additional changes, the process repeats. Upon acceptance of the modifications and refinements, the finalize portion begins 6018. The AI system generates a final application 6019 based on the refinements and the user may then download a patent-ready document 6020.

At step 2010, the system may submit the application (file the application) with a patent office (e.g., USPTO).

This example demonstrates how the AI Patent Coach system can efficiently draft a comprehensive patent application for a complex software invention, leveraging its understanding of technical concepts and patent drafting best practices.

By implementing these components and processes, the AI Patent Coach system provides a comprehensive, efficient, and adaptable solution for automated patent application drafting, significantly reducing the time and effort required while maintaining high-quality output.

### Alternative Embodiments

The AI Patent Coach system described herein can be implemented in various alternative embodiments to suit different needs and technological environments. These alternative embodiments extend the functionality and applicability of the system while maintaining its core features and advantages.

### Cloud-Based Implementation

In one alternative embodiment, the AI Patent Coach system can be implemented as a cloud-based solution. This cloud-based version would allow users to access the system through web browsers or dedicated applications, eliminating the need for local installation and maintenance. The cloud-based implementation offers several advantages:
1. Scalability: The system can easily scale to accommodate varying numbers of users and processing demands.
2. Accessibility: Users can access the system from any device with an internet connection, enabling remote collaboration and flexibility.
3. Automatic updates: The system can be continuously improved and updated without requiring user intervention.
4. Data redundancy and backup: Cloud storage provides enhanced data security and backup capabilities.
5. Resource optimization: Cloud-based computing resources can be dynamically allocated based on demand, improving efficiency.

### Integration With Existing Patent Management Systems

Another alternative embodiment involves integrating the AI Patent Coach system with existing patent management systems. This integration would allow seamless incorporation of the AI-driven drafting capabilities into established workflows. Key features of this integration include:
1. Data synchronization: Automatic synchronization of invention disclosures, prior art references, and other relevant data between the AI Patent Coach and existing systems.
2. Workflow integration: Incorporation of the AI-driven drafting process into existing patent management workflows, including approval processes and docketing systems.
3. User authentication and access control: Leveraging existing user management systems to control access to the AI Patent Coach features.
4. Reporting and analytics: Integration of AI Patent Coach metrics and outputs into existing reporting and analytics tools.
5. Document management: Seamless storage and retrieval of AI-generated patent applications within existing document management systems.

### Customization for Specific Industries or Technology Areas

A third alternative embodiment involves customizing the AI Patent Coach system for specific industries or technology areas. This customization would enhance the system's performance and relevance for particular domains. Features of this customized embodiment include:
1. Specialized technology classification: Refined classification algorithms tailored to specific industry taxonomies or technology hierarchies.
2. Domain-specific language models: Natural language processing models trained on industry-specific patent corpora to improve understanding and generation of technical language.
3. Customized prior art databases: Integration with industry-specific prior art databases or internal company repositories for more targeted prior art searches.
4. Industry-specific claim templates: Pre-defined claim structures and language tailored to common invention types within specific industries.
5. Regulatory compliance checks: Incorporation of industry-specific regulatory requirements and best practices into the drafting process.
6. Custom output formats: Generation of patent applications in formats that align with industry-specific standards or company preferences.

These alternative embodiments demonstrate the flexibility and adaptability of the AI Patent Coach system, allowing it to be tailored to various technological environments, integrated with existing systems, and customized for specific industry needs. By offering these alternative implementations, the system can address a wider range of use cases and provide enhanced value to diverse users in the patent drafting ecosystem.

### INDUSTRIAL APPLICABILITY

The AI Patent Coach system has broad industrial applicability across various sectors of the intellectual property landscape, offering significant benefits to multiple stakeholders involved in the patent application process.

Law firms and patent attorneys can leverage the AI Patent Coach to streamline their workflow and enhance productivity. By automating the initial drafting process, attorneys can focus their expertise on high-value tasks such as strategic claim refinement and client consultation. The system's ability to generate consistent, high-quality patent applications across diverse technology areas enables law firms to expand their service offerings and handle a broader range of clients more efficiently.

Corporate intellectual property departments stand to gain substantial advantages from implementing the AI Patent Coach. Large companies with extensive R&D operations can rapidly convert their innovations into patent-ready documents, maintaining the momentum of their inventive processes. The system's capability to perform thorough prior art searches and iteratively refine applications helps corporate IP teams to develop stronger, more defensible patent portfolios. Additionally, the AI Patent Coach can assist in identifying potential infringement risks early in the development process, allowing companies to make informed decisions about their IP strategies.

Individual inventors and small businesses, often constrained by limited resources, can benefit greatly from the accessibility and efficiency of the AI Patent Coach. The system democratizes the patent application process by providing a cost-effective means of drafting high-quality patent applications. This levels the playing field, allowing smaller entities to protect their innovations without the prohibitive costs typically associated with extensive legal services. The AI Patent Coach's user-friendly interface and ability to guide inventors through the process empowers them to take a more active role in protecting their intellectual property.

Patent offices and examiners can also derive significant value from the widespread adoption of the AI Patent Coach. The system's standardized approach to patent drafting and its ability to ensure comprehensive, well-structured applications can lead to more efficient examination processes. Examiners may find that applications generated by the AI Patent Coach are more consistent in format and content, potentially reducing the time required for initial reviews.

Furthermore, the system's thorough prior art search capabilities may result in applications that more clearly delineate the novel aspects of inventions, facilitating more accurate and expedient patent assessments.

The AI Patent Coach's industrial applicability extends beyond these primary stakeholders. Technology transfer offices in academic institutions can utilize the system to more efficiently protect and commercialize research outputs. Innovation hubs and incubators can offer the AI Patent Coach as a valuable resource to their startup communities, fostering a culture of intellectual property protection among emerging companies.

In summary, the AI Patent Coach has the potential to transform the patent application landscape by enhancing efficiency, improving quality, and increasing accessibility across a wide range of industries and organizations involved in intellectual property protection and innovation.

What is claimed is:

1. A system for automated patent application drafting, comprising:
a processor;
a memory storing instructions that, when executed by the processor, cause the system to:
receive unstructured input describing an invention; classify the invention into a technology area;
generate a set of claims based on the unstructured input and technology area;
draft a patent specification including a background, summary, description of drawings, and detailed description;
perform a vectorized prior art search using a database of patent documents;
iteratively refine the claims and specification based on the prior art search results;
generate flowcharts and drawing descriptions for the invention; and
output a patent-ready application.

2. The system of claim 1, wherein classifying the invention into a technology area comprises analyzing the unstructured input using natural language processing techniques.

3. The system of claim 1, wherein generating the set of claims comprises creating a hierarchy of claims starting with broad independent claims and progressing to more specific dependent claims.

4. The system of claim 1, wherein performing the vectorized prior art search comprises:
converting patent documents into vector representations;
comparing the vector representations of the patent documents to a vector representation of the invention; and
identifying similar patent documents based on vector similarity.

5. The system of claim 1, wherein iteratively refining the claims and specification comprises:
identifying potential conflicts with prior art;
modifying claim language to avoid the identified conflicts; and
updating the specification to support the modified claims.

6. The system of claim 1, wherein generating flowcharts comprises using a diagraming tool to create visual representations of the invention's processes or components.

7. The system of claim 1, further comprising receiving human input to refine specific sections of the patent application.

8. A method for automated patent application drafting, comprising:
receiving, by a computer system, unstructured input describing an invention;
classifying, by the computer system, the invention into a technology area;
generating, by the computer system, a set of claims based on the unstructured input and technology area;
drafting, by the computer system, a patent specification including a background, summary, description of drawings, and detailed description;
performing, by the computer system, a vectorized prior art search using a database of patent documents;
iteratively refining, by the computer system, the claims and specification based on the prior art search results;
generating, by the computer system, flowcharts and drawing descriptions for the invention; and
outputting, by the computer system, a patent application.

9. The method of claim 8, wherein classifying the invention into a technology area comprises analyzing the unstructured input using natural language processing techniques.

10. The method of claim 8, wherein generating the set of claims comprises creating a hierarchy of claims starting with broad independent claims and progressing to more specific dependent claims.

11. The method of claim 8, wherein performing the vectorized prior art search comprises:
converting patent documents into vector representations;
comparing the vector representations of the patent documents to a vector representation of the invention; and
identifying similar patent documents based on vector similarity.

12. The method of claim 8, wherein iteratively refining the claims and specification comprises:
identifying potential conflicts with prior art;
modifying claim language to avoid the identified conflicts; and
updating the specification to support the modified claims.

13. The method of claim 8, wherein generating flowcharts comprises using a diagraming tool to create visual representations of the invention's processes or components.

14. The method of claim 8, further comprising receiving human input to refine specific sections of the patent application.

15. A non-transitory computer-readable storage medium storing instructions that, when executed by a processor, cause the processor to perform operations comprising:
receiving unstructured input describing an invention;
classifying the invention into a technology area;
generating a set of claims based on the unstructured input and technology area;
drafting a patent specification including a background, summary, description of drawings, and detailed description;
performing a vectorized prior art search using a database of patent documents;
iteratively refining the claims and specification based on the prior art search results;
generating flowcharts and drawing descriptions for the invention; and
outputting a patent-ready application.

16. The non-transitory computer-readable storage medium of claim 15, wherein classifying the invention into a technology area comprises analyzing the unstructured input using natural language processing techniques.

17. The non-transitory computer-readable storage medium of claim 15, wherein generating the set of claims comprises creating a hierarchy of claims starting with broad independent claims and progressing to more specific dependent claims.

18. The non-transitory computer-readable storage medium of claim 15, wherein performing the vectorized prior art search comprises:
converting patent documents into vector representations;
comparing the vector representations of the patent documents to a vector representation of the invention; and
identifying similar patent documents based on vector similarity.

19. The non-transitory computer-readable storage medium of claim 15, wherein iteratively refining the claims and specification comprises:
identifying potential conflicts with prior art;
modifying claim language to avoid the identified conflicts; and
updating the specification to support the modified claims.

20. The non-transitory computer-readable storage medium of claim 15, wherein the operations further comprise receiving input from a human to refine specific sections of the patent application.
